(19) United States
(12) Patent Application Publication
(10) Pub. No.: US 2024/0249864 A1
(43) Pub. Date: Jul. 25, 2024

(54) Rare earth ion-doped soft magnetic alloy, soft magnetic composite material and preparation method thereof

(71) Applicant: HENGDIAN GROUP DMEGC MAGNETICS CO., LTD., Dongyang, Zhejiang (CN)

(72) Inventors: Yuping LI, Dongyang, Zhejiang (CN); Yunyi ZHANG, Dongyang, Zhejiang (CN); Yongyang SUN, Dongyang, Zhejiang (CN); Yuntao JIANG, Dongyang, Zhejiang (CN)

(21) Appl. No.: 18/015,730

(22) PCT Filed: Jun. 15, 2022
(86) PCT No.: PCT/CN2022/099006

§ 371 Date: Jan. 12, 2023

(30) Foreign Application Priority Data
Oct. 26, 2021 (CN) 202111249286.3

(51) Int. Cl. H01F 1/153; B22F 1/142; B22F 1/145; B22F 9/08; C22C 38/00; C22C 38/02; C22C 38/06; H01F 1/147; H01F 3/08; H01F 41/02

(52) U.S. Cl. CPC H01F 1/15325; B22F 1/142; B22F 1/145; B22F 9/082; C22C 38/001; C22C 38/005; C22C 38/02; C22C 38/06; H01F 1/14791; H01F 3/08; H01F 41/0293; B22F 2009/0824

(57) ABSTRACT

The present disclosure provides a rare earth ion-doped soft magnetic alloy, a soft magnetic composite material and a preparation method thereof. The rare earth ion-doped soft magnetic alloy is composed of Fe, Si, Al, N and Re, and the Re is a rare earth element; and herein, in the rare earth ion-doped soft magnetic alloy, the content of the Fe is 82-85 wt %, the content of the Si is 8-10 wt %, the content of the Al is 3-5 wt %, the content of the Re is 1-2 wt %, and the content of the N is 0.25-0.65 wt %. Most of the interior of the rare earth ion-doped soft magnetic alloy of the present disclosure is composed of FeSiAl crystal grains, but an appropriate amount of an easy-faced Re—Fe—N compound is dispersed among the FeSiAl crystal grains. Based on such a structure, the rare earth ion-doped soft magnetic alloy of the present disclosure has excellent electromagnetic properties and lower loss under a working condition of MHz.

### CROSS-REFERENCE TO RELATED APPLICATION

The present application is based on and claims priority to Chinese application with CN application number of 202111249286.3 and application date of Oct. 26, 2021. The disclosed content of the CN application is hereby incorporated by reference in its entirety once again.

### TECHNICAL FIELD

The present disclosure relates to the field of magnetic materials, in particular to a rare earth ion-doped soft magnetic alloy, a soft magnetic composite material and a preparation method thereof.

### BACKGROUND

A power inductor plays a role of energy coupling, transmission and conversion in electric power and electronic devices, its miniaturization and integration may improve the device efficiency, reduce the energy consumption and reduce the environmental pollution. In recent years, with the practical application of a third-generation wide bandgap semiconductor material represented by GaN and SiC, it becomes possible to further achieve the high frequency, miniaturization and high power of the electronic devices, and at the same time, the higher requirements are put forward to soft magnetic materials in terms of the high frequency, high saturation magnetic flux density, high permeability and low loss. However, there is currently no soft magnetic material that may be fully matched with the third-generation wide bandgap semiconductor; this already becomes a bottleneck restricting the high frequency and integration of electronic information technologies.

At present, most of inductance devices used in frequency bands above MHz use ferrite as the soft magnetic material. The ferrite soft magnetic material has the higher resistivity and permeability, but the saturation magnetization is lower (Bs<0.5 T), so that the magnetic energy storage capacity thereof is weaker, and it is not beneficial to achieve the miniaturization of a product while used in the electronic devices. In contrast, metal soft magnetic materials, such as Fe, FeNi, FeSi or FeSiAl, have the higher saturation magnetization, and it is beneficial to the miniaturized design of electronic elements. However, due to the low resistivity of this type of the materials, the eddy current loss is very large under a high frequency application condition, so it may generally only work in the frequency band below 1 MHZ. In addition, amorphous and nanocrystalline magnetic powder is a research hotspot in this field in recent years due to the high saturation magnetization and the higher resistivity, but the disadvantages, such as the difficult material forming and harsh stress relief and annealing conditions, limit their application ranges.

In a related technology, patent CN110047637A proposed a preparation method for a rare earth-iron-nitrogen composite magnetic material, an Nd—Fe—N composite rare earth material was prepared, and the electromagnetic absorption and shielding properties of the material were tested. However, the rare earth content of this method was too high, so that its saturation magnetization of the material was lower. Patent document CN110047637A pointed out that the high-frequency characteristics of the metal soft magnetic material may be improved by doping rare earth ions, especially an easy-faced rare earth iron intermetallic compound Re₂Fe₁₇ may be formed. This compound has a high cut-off frequency, and may be used under a condition of GHz. Moreover, if this compound is nitrided, the resistance of the material may also be increased, and the eddy current loss of the material may be reduced. However, although the compound Re₂Fe₁₇ and Re₂Fe₁₇ nitridation products have the better loss characteristics under the condition of GHz, its magnetic permeability and saturation magnetization are relatively low, so that its application is limited under a condition of MHz, and the loss is larger.

Patents CN109982791A, CN100513015C, CN1093311C, CN1286602C and CN1022520C all proposed a method for preparing a new-type rare earth-iron-nitrogen material, such as Sm—Fe—N and Nd—Fe—N. However, due to the differences in alloy composition and microstructure, the above materials have the good permanent magnetic properties and insufficient soft magnetic properties, so they may not be used as the soft magnetic materials for the inductance devices.

J. Magn. Magn. Mater, 2017, 424 (15): 39-43 disclosed a method for preparing a Ce₂Fe₁₇N_{3-δ} compound, and the high frequency (GHz) absorption characteristics of the material were tested. However, the material prepared by this method is mainly used in the ultra-high frequency of GHz, its saturation magnetization and magnetic permeability at MHz are relatively low, and the loss is larger.

A master's thesis of Zhejiang University “FeSi, FeSiAl and FeSiCr Soft Magnetic Composite Material Prepared by Surface Nitriding/Oxidizing Method” (Zhao Jing, 2018) pointed out that by surface-nitriding/oxidizing magnetic powder, the resistivity of the magnetic powder may be increase, thereby the eddy current loss of the magnetic powder is reduced. Although this thesis points out that by surface-nitriding/oxidizing the magnetic powder, the resistivity of the magnetic powder may be increased, thereby the eddy current loss of the magnetic powder is reduced, due to the very stable chemical properties of a N₂ gas, conventional FeSi, FeSiAl and FeSiCr are difficult to fully react with the N₂ gas, so the N content in an alloy is relatively low, so its effect on reducing the eddy current loss of the magnetic powder is still insufficient.

In conclusion, the soft magnetic material in the existing technology may not take into account problems of the high electromagnetic properties and the low loss at the same time under working conditions of MHz and high current. Therefore, it is necessary to provide a soft magnetic material, as to improve the above problems.

### SUMMARY

A main purpose of the present disclosure is to provide a rare earth ion-doped soft magnetic alloy, a soft magnetic composite material and a preparation method thereof, as to solve a problem in an existing technology that a soft magnetic material may not simultaneously take into account the high electromagnetic properties and low loss under working conditions of MHz and high current.

In order to achieve the above purpose, according to one aspect of the present disclosure, a rare earth ion-doped soft magnetic alloy is provided, the rare earth ion-doped soft magnetic alloy is composed of Fe, Si, Al, N and Re, and the Re is a rare earth element; and herein, in the rare earth ion-doped soft magnetic alloy, the content of the Fe is 82-85 wt %, the content of the Si is 8-10 wt %, the content of the Al is 3-5 wt %, the content of the Re is 1-2 wt %, and the content of the N is 0.25-0.65 wt %.

Further, the rare earth element is one or more of Ce, La, Sm, Nd, Pr and Ho.

Further, the average particle diameter of the rare earth ion-doped soft magnetic alloy is 5-50 μm.

In order to achieve the above purpose, according to one aspect of the present disclosure, a preparation method for the above rare earth ion-doped soft magnetic alloy is provided, and the preparation method includes the following steps: under an inert gas atmosphere, mixing iron, an iron-silicon alloy, aluminum and a rare earth metal and smelting, to form a molten body; and performing atomization powder preparation, heat treatment and nitriding treatment on the molten body sequentially, to form the rare earth ion-doped soft magnetic alloy, herein, the rare earth ion-doped soft magnetic alloy is composed of Fe, Si, Al, N and Re, and the Re is a rare earth element; and in the rare earth ion-doped soft magnetic alloy, the content of the Fe is 82%-85 wt %, the content of the Si is 8-10 wt %, the content of the Al is 3-5 wt %, the content of the Re is 1-2 wt %, and the content of the N is 0.25-0.65 wt %.

Further, in the nitriding treatment process, nitrogen is fed into a system to perform the nitriding treatment; preferably, in the nitriding treatment process, the treatment temperature is 450-550° C., and the treatment time is 4-6 h; and preferably, in the nitriding treatment process, the pressure of the nitrogen is 0.1-0.2 MPa.

Further, in the smelting process, the smelting temperature is 1800-2000° C., and the smelting time is 0.5-5 h; preferably, in the heat treatment process, the treatment temperature is 900-1000° C., and the treatment time is 2-3 h; and preferably, a gas atomization device is used to perform the atomization powder preparation; more preferably, in the gas atomization device, an atomizing gas is an inert gas, and its gas pressure is 0.1-1.0 MPa.

According to another aspect of the present disclosure, a soft magnetic composite material is provided, and the soft magnetic composite material includes: a rare earth ion-doped soft magnetic alloy core layer; a phosphating layer, coated on an outer surface of the rare earth ion-doped soft magnetic alloy core layer; a glass layer, coated on an outer surface, away from the rare earth ion-doped soft magnetic alloy core layer, of the phosphating layer; and a lubricating layer, coated on an outer surface, away from the rare earth ion-doped soft magnetic alloy core layer, of the glass layer, herein the lubricating layer is coated on the surface of the glass layer by coupling with a coupling agent, herein, the material of the rare earth ion-doped soft magnetic alloy core layer is the above rare earth ion-doped soft magnetic alloy, the material of the phosphating layer is selected from at least one of an iron phosphate and an aluminum phosphate, the material of the glass layer is one or more of a silicon dioxide, a sodium pyrophosphate or a sodium silicate, and the material of the lubricating layer is a lubricant.

Further, the coupling agent is selected from one or more of a silane coupling agent, a titanate coupling agent or an aluminate coupling agent; preferably, the lubricant is selected from one or more of a zinc stearate, a calcium stearate or a magnesium stearate; preferably, the average particle diameter of the soft magnetic composite material is 10-40 μm; and preferably, the thickness of the phosphating layer is 10-50 nm, the thickness of the glass layer is 10-50 nm, and the thickness of the lubricating layer is 10-50 nm.

According to another aspect of the present disclosure, a preparation method for the above soft magnetic composite material is provided, and the preparation method includes the following steps: providing a rare earth ion-doped soft magnetic alloy core layer, as to coat a phosphating layer on an outer surface of the rare earth ion-doped soft magnetic alloy core layer; coating a glass layer on an outer surface, away from the rare earth ion-doped soft magnetic alloy core layer, of the phosphating layer; and coating a lubricating layer on an outer surface, away from the rare earth ion-doped soft magnetic alloy core layer, of the glass layer by coupling with a coupling agent, thereby forming the soft magnetic composite material, herein, the material of the rare earth ion-doped soft magnetic alloy core layer is the above rare earth ion-doped soft magnetic alloy, the material of the phosphating layer is selected from at least one of an iron phosphate and an aluminum phosphate, the material of the glass layer is one or more of a silicon dioxide, a sodium pyrophosphate or a sodium silicate, and the material of the lubricating layer is a lubricant.

Further, the preparation method includes: in a vacuum environment, mixing first dispersion liquid containing the rare earth ion-doped soft magnetic alloy core layer and a phosphoric acid, and performing first stirring, so that the phosphoric acid is reacted with the material in a surface area of the rare earth ion-doped soft magnetic alloy core layer to coat the outer surface thereof and form the phosphating layer, to obtain an intermediate material A, herein the material of the phosphating layer contains the iron phosphate and the aluminum phosphate; under a condition of pH 6.0-8.0, performing second stirring on second dispersion liquid containing the intermediate material A, the ethyl silicate, the sodium pyrophosphate and the sodium silicate, as to react on the outer surface, away from the rare earth ion-doped soft magnetic alloy core layer, of the phosphating layer and form the glass layer, to obtain an intermediate material B, herein the glass layer contains the silicon dioxide, the sodium pyrophosphate and the sodium silicate; performing third stirring on third dispersion liquid containing the intermediate material B and the coupling agent, as to connect the coupling agent on the outer surface, away from the rare earth ion-doped soft magnetic alloy core layer, of the glass layer, to obtain an intermediate material C; and mixing the intermediate material C and the lubricant, and performing fourth stirring, so that the lubricant is coated on the surface of the glass layer by coupling with the coupling agent to form the lubricating layer, thereby forming the soft magnetic composite material.

Further, the usage amount of the phosphoric acid is 0.5-1% of the weight of the rare earth ion-doped soft magnetic alloy core layer; preferably, the usage amount of the ethyl silicate is 0.5-1% of the weight of the rare earth ion-doped soft magnetic alloy core layer, the usage amount of the sodium pyrophosphate is 0.2-0.5% of the weight of the rare earth ion-doped soft magnetic alloy core layer, and the usage amount of the sodium silicate is 0.5-1% of the weight of the rare earth ion-doped soft magnetic alloy core layer; preferably, the usage amount of the coupling agent is 0.5-1.0% of the weight of the rare earth ion-doped soft magnetic alloy core layer; and preferably, the usage amount of the lubricant is 0.1-1% of the weight of the rare earth ion-doped soft magnetic alloy core layer.

Further, the treatment temperatures of the first stirring, the second stirring, the third stirring and the fourth stirring are each independently selected from 50-100° C., and the treatment times are each independently 1-5 h.

According to another aspect of the present disclosure, an application of the above soft magnetic composite material in an inductance device of a MHz frequency band is provided.

Most of the interior of the rare earth ion-doped soft magnetic alloy of the present disclosure is composed of a FeSiAl crystal grain, but a small amount of an easy-faced Re—Fe—N compound is scattered and distributed among the FeSiAl crystal grains. Based on such a structure, the rare earth ion-doped soft magnetic alloy of the present disclosure also has the excellent electromagnetic properties and low loss while it is subsequently applied under the working condition of MHz.

### DETAILED DESCRIPTION OF THE EMBODIMENTS

It should be noted that embodiments in the present application and features of the embodiments may be combined with each other in the case without conflicting. The present disclosure is described in detail below with reference to the embodiments.

As described in the background section, the soft magnetic material in the existing technology may not simultaneously take into account the high electromagnetic properties and low loss under the working conditions of MHz and high current.

In order to solve this problem, the present disclosure provides a rare earth ion-doped soft magnetic alloy, the rare earth ion-doped soft magnetic alloy is composed of Fe, Si, Al, N and Re, and the Re is a rare earth element; and herein, in the rare earth ion-doped soft magnetic alloy, the content of the Fe is 82-85 wt %, the content of the Si is 8-10 wt %, the content of the Al is 3-5 wt %, the content of the Re is 1-2 wt %, and the content of the N is 0.25-0.65 wt %.

In the present disclosure, by controlling the weight content of the Fe, Si, Al, N and Re within the above ranges, on the one hand, the rare earth element is more likely to adsorb an N element, and an easy-faced Re—Fe—N compound may be formed inside the soft magnetic alloy. In the soft magnetic alloy structure of the present disclosure, most of the interior of the soft magnetic alloy is composed of a FeSiAl crystal grain, and a small amount of the easy-faced Re—Fe—N compound is scattered and distributed among the FeSiAl crystal grains. The easy-faced Re—Fe—N compound acts as a substance with high resistivity, so that FeSiAl with low resistivity becomes discontinuous, thereby the resistivity of the soft magnetic alloy is improved, and the eddy current loss of the material is effectively reduced. On the other hand, the formation of the excessive Re—Fe—N compound is avoided, thereby a problem of lowering the saturation magnetization and magnetic permeability of the material is effectively avoided, and the material of the present disclosure is promoted to also have the excellent electromagnetic properties and lower loss under the working condition of MHz. Specifically, in the subsequent application process, it may be matched with a third-generation wide bandgap semiconductor more highly, and is more suitable for the requirements of miniaturization, high frequency and high power of inductance devices.

In order to further balance the electromagnetic properties and loss of the material under the working condition of MHz, preferably the rare earth element is one or more of Ce, La, Sm, Nd, Pr or Ho.

In a preferred embodiment, the average particle diameter of the rare earth ion-doped soft magnetic alloy is 5-50 μm. Based on this, the particle diameter of the material is more suitable for the application under the working condition of MHZ, and under this condition, it has the excellent electromagnetic properties and lower loss. It is more suitable for the requirements of the miniaturization, high frequency and high power of the inductance devices.

In a preferred embodiment, in the rare earth ion-doped soft magnetic alloy, the content of the Fe is 83 wt %, the content of the Si is 9.45 wt %, the content of the Al is 5 wt %, the content of the Re is 2 wt %, and the content of the N is 0.55 wt %; or in the rare earth ion-doped soft magnetic alloy, the content of the Fe is 85 wt %, the content of the Si is 9.5 wt %, the content of the Al is 3 wt %, the content of the Re is 2 wt %, and the content of the N is 0.50 wt %; or in the rare earth ion-doped soft magnetic alloy, the content of the Fe is 85 wt %, the content of the Si is 8.75 wt %, the content of the Al is 5 w %, the content of the Re is 1 wt %, and the content of the N is 0.25 wt %; or in the rare earth ion-doped soft magnetic alloy, the content of the Fe is 85 wt %, the content of the Si is 7.47 wt %, the content of the Al is 5 wt %, the content of the Re is 2 wt %, and the content of the N is 0.53 wt %; or in the rare earth ion-doped soft magnetic alloy, the content of the Fe is 83 wt %, the content of the Si is 8.47 wt %, the content of the Al is 6 wt %, the content of the Re is 2 wt %, and the content of the N is 0.53 wt % %; or in the rare earth ion-doped soft magnetic alloy, the content of the Fe is 83 wt %, the content of the Si is 9.39 wt %, the content of the Al is 5 wt %, the content of the Re is 2 wt %, and the content of the N is 0.61 wt %; or in the rare earth ion-doped soft magnetic alloy, the content of the Fe is 83 wt %, the content of the Si is 10 wt %, the content of the Al is 5 wt %, the content of the Re is 2 wt %, and the content of the N is 0.25 wt %.

The present disclosure further provides a preparation method for the above rare earth ion-doped soft magnetic alloy, and the preparation method includes the following steps: under an inert gas atmosphere, mixing iron, an iron-silicon alloy, aluminum and a rare earth metal and smelting, to form a molten body; and performing atomization powder preparation, heat treatment and nitriding treatment on the molten body sequentially, to form the rare earth ion-doped soft magnetic alloy, herein, the rare earth ion-doped soft magnetic alloy is composed of Fe, Si, Al, N and Re, and the Re is a rare earth element; and in the rare earth ion-doped soft magnetic alloy, the content of the Fe is 82-85 wt %, the content of the Si is 8-10 wt %, the content of the Al is 3-5 wt %, the content of the Re is 1-2 wt %, and the content of the N is 0.25-0.65 wt %.

Based on the above reasons, the present disclosure adopts the above preparation method. On the one hand, the rare earth element is more likely to adsorbing the N element, and the easy-faced Re—Fe—N compound may be formed inside the soft magnetic alloy. In the soft magnetic alloy structure of the present disclosure, most of the interior of the soft magnetic alloy is composed of the FeSiAl crystal grain, and a small amount of the easy-faced Re—Fe—N compound is scattered and distributed among the FeSiAl crystal grains. The easy-faced Re—Fe—N compound acts as a substance with high resistivity, so that FeSiAl with low resistivity becomes discontinuous, thereby the resistivity of the soft magnetic alloy is improved, and the eddy current loss of the material is effectively reduced. On the other hand, the formation of the excessive Re—Fe—N compound is avoided, thereby a problem of lowering the saturation magnetization and magnetic permeability of the material is effectively avoided, and the material of the present disclosure is promoted to also have the excellent electromagnetic properties and lower loss under the working condition of MHz. Specifically, in the subsequent application process, it may be matched with a third-generation wide bandgap semiconductor more highly, and is more suitable for the requirements of miniaturization, high frequency and high power of inductance devices. In addition, preparation raw materials selected in the present disclosure, such as iron, an iron-silicon alloy, and aluminum, are more easily available, and lower in cost, and the preparation process is simpler and easier to operate.

Preferably, in the nitriding treatment process, N₂ is fed into a system to perform the nitriding treatment. Based on this, the nitriding treatment process is more convenient to operate and easier to control, so the formation of the easy-faced Re—Fe—N compound may be further controlled better, and the electromagnetic properties are also better on the basis of reducing the eddy current loss of the material. Preferably, in the nitriding treatment process, the treatment temperature is 450-550° C., and the treatment time is 4-6 h; and the nitrogen pressure is 0.1-0.2 MPa. Based on this, the easy-faced Re—Fe—N compound may be more uniformly scattered and distributed among the FeSiAl crystal grains, thereby the electromagnetic properties and loss of the material under the working condition of MHz are further balanced. If the above treatment temperature is lower than 450° C., the nitridation of the magnetic powder is incomplete, and the nitrogen content is too low, it may lead to an increase in the eddy current loss of the magnetic powder. However, if the above treatment temperature is higher than 550° C., the formed easy-faced Re—Fe—N compound is easily decomposed to generate other compounds; thereby it may lead to the increase in the eddy current loss of the magnetic powder.

In a preferred embodiment, in the smelting process, the smelting temperature is 1800-2000° C., and the smelting time is 0.5-5 h. In the heat treatment process, the treatment temperature is 900-1000° C., and the treatment time is 2-3 h. Based on this, the above structural properties of the material are better, and the material has the better electromagnetic properties and lower loss.

Preferably, a gas atomization device is used to perform the atomization powder preparation; more preferably, in the gas atomization device, an atomizing gas is an inert gas, and its gas pressure is 0.1-1.0 MPa. Based on this, the particle diameter of the material is more suitable for the application under the working condition of MHz, and under this condition, it has the excellent electromagnetic properties and lower loss. It is more suitable for the requirements of the miniaturization, high frequency and high power of the inductance devices.

The present disclosure further provides a soft magnetic composite material, and the soft magnetic composite material includes: a rare earth ion-doped soft magnetic alloy core layer; a phosphating layer, coated on an outer surface of the rare earth ion-doped soft magnetic alloy core layer; a glass layer, coated on an outer surface, away from the rare earth ion-doped soft magnetic alloy core layer, of the phosphating layer; and a lubricating layer, coated on an outer surface, away from the rare earth ion-doped soft magnetic alloy core layer, of the glass layer, herein the lubricating layer is coated on the surface of the glass layer by coupling with a coupling agent, herein, the material of the rare earth ion-doped soft magnetic alloy core layer is the above rare earth ion-doped soft magnetic alloy, the material of the phosphating layer is selected from at least one of an iron phosphate and an aluminum phosphate, the material of the glass layer is one or more of a silicon dioxide, a sodium pyrophosphate or a sodium silicate, and the material of the lubricating layer is a lubricant.

Based on the above reasons, most of the interior of the rare earth ion-doped soft magnetic alloy of the present disclosure is composed of the FeSiAl crystal grain, but a small amount of the easy-faced Re—Fe—N compound is scatter and distributed among the FeSiAl crystal grains. Based on such a structure, the rare earth ion-doped soft magnetic alloy of the present disclosure is promoted to also have the excellent electromagnetic properties and lower loss under the working condition of MHz.

On this basis, the present disclosure uses the above alloy as a core layer, and further coats the surface of the alloy core layer with the phosphating layer, the glass layer, the coupling layer and the lubricating layer sequentially, to form a soft magnetic composite material structure with a multi-layer coating film, so that the insulating properties and pressing properties of the composite material are further improved, and the improved insulating properties may further reduce the eddy current loss between the rare earth ion-doped soft magnetic alloys. Specifically, the synergy of the phosphating layer and the glass layer may further improve the insulating properties of the material, the lubricating layer may further improve the pressing properties of the material, and the intermediate coupling layer acts as a transition connection layer between an inorganic material (glass layer) and an organic material (lubricating layer) layer, which may further balance the insulating properties and pressing properties of the material.

Therefore, the composite material based on this structure, while the rare earth ion-doped soft magnetic alloys are used synergistically with each other, has the better electromagnetic properties and has the lower loss, and in the subsequent application process, it may be matched with the third-generation wide bandgap semiconductor more highly, and more suitable for the requirements of the miniaturization, high frequency and high power of the inductance devices.

In order to further balance the beneficial electromagnetic properties and lower loss properties of the material, and further improve the pressing properties of the material, preferably, the average particle diameter of the soft magnetic composite material is 10-40 μm; preferably, the thickness of the phosphating layer is 10-50 nm, the thickness of the glass layer is 10-50 nm, the thickness of the coupling layer is 10-50 nm, and the thickness of the lubricating layer is 10-50 nm.

The present disclosure further provides a preparation method for the above soft magnetic composite material, and the preparation method includes the following steps: providing a rare earth ion-doped soft magnetic alloy core layer, as to coat a phosphating layer on an outer surface of the rare earth ion-doped soft magnetic alloy core layer; coating a glass layer on an outer surface, away from the rare earth ion-doped soft magnetic alloy core layer, of the phosphating layer; and coating a lubricating layer on an outer surface, away from the rare earth ion-doped soft magnetic alloy core layer, of the glass layer by coupling with a coupling agent, thereby forming the soft magnetic composite material, herein, the material of the rare earth ion-doped soft magnetic alloy core layer is the above rare earth ion-doped soft magnetic alloy, the material of the phosphating layer is selected from at least one of an iron phosphate and an aluminum phosphate, the material of the glass layer is one or more of a silicon dioxide, a sodium pyrophosphate or a sodium silicate, and the material of the lubricating layer is a lubricant.

Based on the reasons described above, the present disclosure uses the above alloy as a core layer, and further coats the surface of the alloy core layer with the phosphating layer, the glass layer, the coupling layer and the lubricating layer sequentially, to form a soft magnetic composite material structure with a multi-layer coating film, so that the insulating properties and pressing properties of the composite material are further improved, and the improved insulating properties may further reduce the eddy current loss of the material. Therefore, the composite material based on this structure has the lower loss on the basis of the better electromagnetic properties, and in the subsequent application process, it may be matched with the third-generation wide bandgap semiconductor more highly, and more suitable for the requirements of the miniaturization, high frequency and high power of the inductance devices.

In a preferred embodiment, the preparation method includes: in a vacuum environment, mixing first dispersion liquid containing the rare earth ion-doped soft magnetic alloy core layer and a phosphoric acid, and performing first stirring, so that the phosphoric acid is reacted with the material in a surface area of the rare earth ion-doped soft magnetic alloy core layer to coat the outer surface thereof and form the phosphating layer, to obtain an intermediate material A, herein the material of the phosphating layer contains the iron phosphate and the aluminum phosphate; under a condition of pH 6.0-8.0, performing second stirring on second dispersion liquid containing the intermediate material A, the ethyl silicate, the sodium pyrophosphate and the sodium silicate, as to react on the outer surface, away from the rare earth ion-doped soft magnetic alloy core layer, of the phosphating layer and form the glass layer, to obtain an intermediate material B, herein the glass layer contains the silicon dioxide, the sodium pyrophosphate and the sodium silicate; performing third stirring on third dispersion liquid containing the intermediate material B and the coupling agent, as to connect the coupling agent on the outer surface, away from the rare earth ion-doped soft magnetic alloy core layer, of the glass layer, to obtain an intermediate material C; and mixing the intermediate material C and the lubricant, and performing fourth stirring, so that the lubricant is coated on the surface of the glass layer by coupling with the coupling agent to form the lubricating layer, thereby forming the soft magnetic composite material.

Based on this operation, the synergy of the phosphating layer and the glass layer may further improve the insulating properties of the material, the lubricating layer may further improve the pressing properties of the material, and the intermediate coupling layer acts as a transition connection layer between an inorganic material (glass layer) and an organic material (lubricating layer) layer, which may further balance the insulating properties and pressing properties of the material. While the rare earth ion-doped soft magnetic alloys are used synergistically with each other subsequently, its loss is smaller on the basis of the better electromagnetic properties, and in the subsequent application process, it may be matched with the third-generation wide bandgap semiconductor more highly, and more suitable for the requirements of the miniaturization, high frequency and high power of the inductance devices.

In a preferred embodiment, in the fourth stirring process of mixing the intermediate material C and the lubricant, a silicon resin may be added to the system, so that the insulating properties of the composite material may be further improved, and it is also helpful to further improve the forming properties of the material. Preferably, the usage amount of the silicon resin is 0.5-1% of the weight of the rare earth ion-doped soft magnetic alloy core layer.

In a preferred embodiment, the intermediate material obtained in each step may be heated to 80° C. to dry the material, and then put into the next preparation step. Based on this, the above excellent structural properties of the material are better.

In an optional embodiment, the material after the above fourth stirring may be cooled to a room temperature, then the material is broken up with a crusher, and sieved with a 300-400-mesh sieve, to obtain the soft magnetic composite material.

Preferably, the usage amount of the phosphoric acid is 0.5-1% of the weight of the rare earth ion-doped soft magnetic alloy core layer. While the usage amount of the phosphoric acid is lower than 0.5%, the passivation effect of the magnetic powder may be slightly worse; thereby the resistivity of the material is reduced, so that the high-frequency eddy current loss is slightly increased. While the usage amount of the phosphoric acid is higher than 1%, it may cause the magnetic powder to react with the excess phosphoric acid, thereby the saturation magnetization of the material is reduced.

Preferably, the usage amount of the ethyl silicate is 0.5-1% of the weight of the rare earth ion-doped soft magnetic alloy core layer, the usage amount of the sodium pyrophosphate is 0.2-0.5% of the weight of the rare earth ion-doped soft magnetic alloy core layer, and the usage amount of the sodium silicate is 0.5-1% of the weight of the rare earth ion-doped soft magnetic alloy core layer. If the usage amounts of the ethyl silicate, the sodium pyrophosphate and the sodium silicate are lower than the above ranges, the thickness of the glass layer may be thinner, and the good insulating effect may not be achieved. If the usage amounts are higher than the above ranges, it may lead to too many non-magnetic substances, and reduce the soft magnetic properties of the magnetic powder.

Preferably, the usage amount of the silane coupling agent is 0.5-1.0% of the weight of the rare earth ion-doped soft magnetic alloy core layer. Based on this, the connection effect between the glass layer and the lubricating layer is better, and the structural properties of the material are more stable. More preferably, the silane coupling agent is selected from one or more of a silane coupling agent, a titanate coupling agent or an aluminate coupling agent.

In order to further improve the press-forming properties of the material, preferably the usage amount of the lubricant is 0.1-1% of the weight of the rare earth ion-doped soft magnetic alloy core layer. More preferably the lubricant is selected from one or more of a zinc stearate, a calcium stearate or a magnesium stearate.

In a preferred embodiment, in the first stirring process, the treatment temperature is 50-100° C., and the treatment time is 1-5 h. Based on this, the formation of the phosphating layer is more stable and the structure is more dense. In a preferred embodiment, in the second stirring process, the treatment temperature is 50-100° C., and the treatment time is 1-5 h. Based on this, the glass layer may be more smoothly and synergistically coated on the phosphating layer, and further improve the insulation of the core layer. In a preferred embodiment, in the third stirring process, the treatment temperature is 50-100° C., and the treatment time is 1-5 h. In the fourth stirring process, the treatment temperature is 50-100° C., and the treatment time is 1-5 h. Based on this, the lubricating layer may be more stably coated on the glass layer, which further improves the insulating properties and press-forming properties of the material.

The present disclosure further provides an application of the above soft magnetic composite material in an inductance device in a frequency band above MHz. Based on the above reasons, on the basis of the better electromagnetic characteristics, its loss is smaller, and in the subsequent application process, it may be matched with the third-generation wide bandgap semiconductor more highly, and more suitable for the requirements of the miniaturization, high frequency and high power of the inductance devices.

The present application is further described in detail below with reference to specific embodiments, but these embodiments should not be construed as limiting a scope of protection claimed by the present application.

### Embodiment 1

Preparation of rare earth ion-doped soft magnetic alloy
(1) Firstly the following initial materials were prepared: iron, iron-silicon alloy, metal aluminum and rare earth metal cerium.
(2) The iron, iron-silicon alloy, metal aluminum and rare earth metal cerium were smelted under a condition of Ar gas protection, to form a molten body, herein the smelting temperature was 1900° C., and the smelting time was 3 h.
(3) The molten body performed atomization powder preparation in an Ar gas environment by a gas atomization device, herein the atomization gas pressure was 0.5 MPa.
(4) Atomized powder was heat-treated at 900° C. in the Ar gas environment for 2 h.
(5) The treatment temperature was reduced to 450° C., then an Ar gas was pumped out, and N₂ was fed for 4 h of the nitriding treatment, and in the treatment process, the nitrogen pressure was always maintained at 0.1 MPa.
(6) The powder was cooled to a room temperature, to obtain a rare earth ion-doped soft magnetic alloy, and in the rare earth ion-doped soft magnetic alloy, the content of Fe was 83 wt %, the content of Si was 9.45 wt %, the content of Al was 5 wt %, the content of Ce was 2 wt %, and the content of N was 0.55 wt %.

Preparation of soft magnetic composite material
(7) The above rare earth ion-doped soft magnetic alloy was immersed in alcohol, then a phosphoric acid which was 0.5% of the weight of the rare earth ion-doped soft magnetic alloy was added to the alcohol, it was stirred in a vacuum environment for 1 h, and then heated to 80° C. to dry, an intermediate material A was obtained.
(8) An ethyl silicate which was 0.5% of the weight of the rare earth ion-doped soft magnetic alloy, 0.2% of a sodium pyrophosphate and 0.5% of a sodium silicate are dispersed with the alcohol, and poured into the above intermediate material A, so that it becomes a slurry material, then it was stirred at a high speed for 1 h, and in the stirring process, ammonia water was added to the slurry material, so that a pH value of the slurry material was close to 8.0, and then it was heated to 80° C. to dry, an intermediate material B was obtained.
(9) A KH550 silane coupling agent which was 0.5% of the weight of the rare earth ion-doped soft magnetic alloy was diluted with the alcohol, it was added to the above intermediate material B and stirred for 1 h, and then dried at 80° C.
(10) A zinc stearate which was 0.1% of the weight of the rare earth ion-doped soft magnetic alloy was added, stirred at 80 degrees for 30 min, then a silicon resin which was 1% of the weight of the rare earth ion-doped soft magnetic alloy was added, and continuously stirred for 1 h.
(11) The material treated in the step (10) was cooled to the room temperature, and then the material was broken up with a crusher, and sieved with a 300-mesh sieving device, to obtain the soft magnetic composite material.

The material was press-formed under a pressure of 1600 MPa, to obtain a ring sample with an outer diameter of 20 mm, an inner diameter of 10 mm, and a height of 5 mm.

### Embodiment 2

A difference from Embodiment 1 is only that: in the rare earth ion-doped soft magnetic alloy, the content of Fe was 85 wt %, the content of Si was 9.5 wt %, the content of Al was 3 wt %, the content of Ce was 2 wt %, and the content of N was 0.50 wt %.

### Embodiment 3

A difference from Embodiment 1 is only that: in the rare earth ion-doped soft magnetic alloy, the content of Fe was 85 wt %, the content of Si was 8.75 wt %, the content of Al was 5 wt %, the content of Ce was 1 wt %, and the content of N was 0.25 wt %.

### Embodiment 4

A difference from Embodiment 1 is only that: in the rare earth ion-doped soft magnetic alloy, the content of Fe was 85 wt %, the content of Si was 7.47 wt %, the content of Al was 5 wt %, the content of Ce was 2 wt %, and the content of N was 0.53 wt %.

### Embodiment 5

A difference from Embodiment 1 is only that: in the rare earth ion-doped soft magnetic alloy, the content of Fe was 83 wt %, the content of Si was 8.47 wt %, the content of Al was 6 wt %, the content of Ce was 2 wt %, and the content of N was 0.53 wt %.

### Embodiment 6

A difference from Embodiment 1 is only that in the step (5), the treatment temperature of the nitriding treatment was 550° C., and the time was 6 h.

In the rare earth ion-doped soft magnetic alloy, the content of Fe was 83 wt %, the content of Si was 9.39 wt %, the content of Al was 5 wt %, the content of Ce was 2 wt %, and the content of N was 0.61 wt %.

### Embodiment 7

A difference from Embodiment 1 is only that in the step (7), the amount of the phosphoric acid added was 1 wt %.

### Embodiment 8

A difference from Embodiment 1 is only that in the step (8), the usage amount of the ethyl silicate was 1 wt %, the usage amount of the sodium pyrophosphate was 0.5 wt %, and the usage amount of the sodium silicate was 1 wt %.

### Embodiment 9

A difference from Embodiment 1 is only that in the step (5), the treatment temperature of the nitriding treatment was 380° C.

A rare earth ion-doped soft magnetic alloy was obtained, and in the rare earth ion-doped soft magnetic alloy, the content of Fe was 83 wt %, the content of Si was 10 wt %, the content of Al was 5 wt %, the content of Ce was 2 wt %, and the content of N was 0.25 wt %.

### Embodiment 10

A difference from Embodiment 1 is only that in the step (9), the usage amount of the coupling agent was 1 wt %.

### Embodiment 11

A difference from Embodiment 1 is only that in the step (10), the usage amount of the lubricant was 1 wt %.

### Contrast Example 1

(1) Firstly the following initial materials were prepared: iron, iron-silicon alloy, and metal aluminum.
(2) The iron, iron-silicon alloy, and metal aluminum were fed, and a proportion was adjusted, so that the weight ratios of Fe, Si, and Al in feed were 85 wt %, 10 wt %, and 5 wt % respectively; and then it was smelted under a condition of Ar gas protection to form a molten body, herein the smelting temperature was 1900° C., and the smelting time was 3 h.
(3) The molten body performs atomization powder preparation in an Ar gas environment by a gas atomization device, herein the atomization gas pressure was 0.5 MPa.
(4) Atomized powder was heat-treated at 900° C. in the Ar gas environment for 2 h, to obtain FeSiAl alloy powder.

The prepared FeSiAl alloy powder was sieved with a 300-mesh sieve, and press-formed under a pressure of 1600 MPa, to obtain a ring sample with an outer diameter of 20 mm, an inner diameter of 10 mm, and a height of 5 mm.

### Contrast Example 2

A different from Embodiment 1 is only that: in the rare earth ion-doped soft magnetic alloy, the content of Fe was 80 wt %, the content of Si was 15 wt %, the content of Al was 4.5 wt %, the content of Ce was 0.5 wt %, and the content of N was 0.12 wt %.

### Contrast Example 3

A different from Embodiment 1 is only that: in the rare earth ion-doped soft magnetic alloy, the content of Fe was 90 wt %, the content of Si was 5 wt %, the content of Al was 1 wt %, the content of Ce was 4 wt %, and the content of N was 1.0 wt %.

### Performance Test:

The composite materials of the above embodiments and contrast examples were tested under conditions of 1 MHz and 50 mT, and its performance results were shown in Table 1 below.

TABLE 1

| | Saturation | | |
|---|---|---|---|
| | magne- | Magnetic | |
| | tization | permeability | Loss |
| Soft magnetic composite | 0.79 T | 70 | 1750 mW/cm³ |
| material in Embodiment 1 | | | |
| Soft magnetic composite | 0.82 T | 75 | 1920 mW/cm³ |
| material in Embodiment 2 | | | |
| Soft magnetic composite | 0.83 T | 75 | 2010 mW/cm³ |
| material in Embodiment 3 | | | |
| Soft magnetic composite | 0.82 T | 77 | 2060 mW/cm³ |
| material in Embodiment 4 | | | |
| Soft magnetic composite | 0.75 T | 58 | 1730 mW/cm³ |
| material in Embodiment 5 | | | |
| Soft magnetic composite | 0.78 T | 69 | 1710 mW/cm³ |
| material in Embodiment 6 | | | |
| Soft magnetic composite | 0.77 T | 66 | 1670 mW/cm³ |
| material in Embodiment 7 | | | |
| Soft magnetic composite | 0.77 T | 63 | 1710 mW/cm³ |
| material in Embodiment 8 | | | |
| Soft magnetic composite | 0.79 T | 71 | 2150 mW/cm³ |
| material in Embodiment 9 | | | |
| Soft magnetic composite | 0.78 T | 69 | 1735 mW/cm³ |
| material in Embodiment 10 | | | |
| Soft magnetic composite | 0.79 T | 69 | 1720 mW/cm³ |
| material in Embodiment 11 | | | |
| Soft magnetic composite | 0.80 T | 69 | 2406 mW/cm³ |
| material in Contrast | | | |
| example 1 | | | |
| Soft magnetic composite | 0.68 T | 55 | 2312 mW/cm³ |
| material in Contrast | | | |
| example 2 | | | |
| Soft magnetic composite | 0.82 T | 71 | 4012 mW/cm³ |
| material in Contrast | | | |
| example 3 | | | |

Compared with Embodiment 1, Embodiment 6, Embodiment 10, Embodiment 11 and Contrast example 1, it may be seen that the saturation magnetization and magnetic permeability of Embodiment 1, Embodiment 6, Embodiment 10 and Embodiment 11 are basically the same as those of Contrast example 1, but the loss in Contrast example 1 is increased substantially. Compared with Embodiments 1 to 11 and Contrast example 2, it may be seen that, in Contrast example 2, the saturation magnetization and magnetic permeability are significantly reduced, and the loss is also substantially increased. Compared with Embodiment 2, Embodiment 3, Embodiment 4 and Contrast example 3, it may be seen that the saturation magnetization and magnetic permeability of Embodiment 2, Embodiment 3, and Embodiment 4 are basically the same as those of Contrast example 3, but the loss in Contrast example 3 is significantly increased.

1. A rare earth ion-doped soft magnetic alloy, composing Fe, Si, Al, N and Re, the Re is a rare earth element; and in the rare earth ion-doped soft magnetic alloy, the content of the Fe is 82-85 wt %, the content of the Si is 8-10 wt %, the content of the Al is 3-5 wt %, the content of the Re is 1-2 wt %, and the content of the N is 0.25-0.65 wt %.

2. The rare earth ion-doped soft magnetic alloy according to claim 1, wherein the rare earth element is selected from at least one of Ce, La, Sm, Nd, Pr and Ho.

3. The rare earth ion-doped soft magnetic alloy according to claim 1, wherein the average particle diameter of the rare earth ion-doped soft magnetic alloy is 5-50 μm.

4. A preparation method for the rare earth ion-doped soft magnetic alloy according to claim 1, wherein the preparation method comprises the following steps:
under an inert gas atmosphere, mixing iron, an iron-silicon alloy, aluminum and a rare earth metal and smelting to form a molten body; and
performing atomization powder preparation, heat treatment and nitriding treatment on the molten body sequentially, to form the rare earth ion-doped soft magnetic alloy,
wherein the rare earth ion-doped soft magnetic alloy is composed of Fe, Si, Al, N and Re, and the Re is a rare earth element; and in the rare earth ion-doped soft magnetic alloy, the content of the Fe is 82%-85 wt %, the content of the Si is 8-10 wt %, the content of the Al is 3-5 wt %, the content of the Re is 1-2 wt %, and the content of the N is 0.25-0.65 wt %.

5. The preparation method according to claim 4, wherein in the nitriding treatment process, nitrogen is fed into a system to perform the nitriding treatment:
preferably, in the nitriding treatment process, the treatment temperature is 450-550° C., and the treatment time is 4-6 h; and
preferably, in the nitriding treatment process, the pressure of the nitrogen is 0.1-0.2 MPa.

6. The preparation method according to claim 4, wherein in the smelting process, the smelting temperature is 1800-2000° C., and the smelting time is 0.5-5 h;
preferably, in the heat treatment process, the treatment temperature is 900-1000° C., and the treatment time is 2-3 h; and
preferably, a gas atomization device is used to perform the atomization powder preparation: more preferably, in the gas atomization device, an atomizing gas is an inert gas, and its gas pressure is 0.1-1.0 MPa.

7. A soft magnetic composite material, wherein the soft magnetic composite material comprises:
a rare earth ion-doped soft magnetic alloy core layer;
a phosphating layer, coated on an outer surface of the rare earth ion-doped soft magnetic alloy core layer;
a glass layer, coated on an outer surface, away from the rare earth ion-doped soft magnetic alloy core layer, of the phosphating layer; and
a lubricating layer, coated on an outer surface, away from the rare earth ion-doped soft magnetic alloy core layer, of the glass layer, wherein the lubricating layer is coated on the surface of the glass layer by coupling with a coupling agent,
wherein, the material of the rare earth ion-doped soft magnetic alloy core layer is the rare earth ion-doped soft magnetic alloy according to claim 1, the material of the phosphating layer is selected from at least one of an iron phosphate and an aluminum phosphate, the material of the glass layer is one or more of a silicon dioxide, a sodium pyrophosphate or a sodium silicate, and the material of the lubricating layer is a lubricant.

8. The soft magnetic composite material according to claim 7, wherein the coupling agent is selected from one or more of a silane coupling agent, a titanate coupling agent or an aluminate coupling agent;
preferably, the lubricant is selected from one or more of a zine stearate, a calcium stearate or a magnesium stearate;
preferably, the average particle diameter of the soft magnetic composite material is 10-40 μm; and
preferably, the thickness of the phosphating layer is 10-50 nm, the thickness of the glass layer is 10-50 nm, and the thickness of the lubricating layer is 10-50 nm.

9. A preparation method for the soft magnetic composite material according to claim 7, wherein the preparation method comprises the following steps:
providing a rare earth ion-doped soft magnetic alloy core layer, as to coat a phosphating layer on an outer surface of the rare earth ion-doped soft magnetic alloy core layer;
coating a glass layer on an outer surface, away from the rare earth ion-doped soft magnetic alloy core layer, of the phosphating layer; and
coating a lubricating layer on an outer surface, away from the rare earth ion-doped soft magnetic alloy core layer, of the glass layer by coupling with a coupling agent, thereby forming the soft magnetic composite material,
wherein, the material of the rare earth ion-doped soft magnetic alloy core layer is the rare earth ion-doped soft magnetic alloy according to claim 1, the material of the phosphating layer is selected from at least one of an iron phosphate and an aluminum phosphate, the material of the glass layer is one or more of a silicon dioxide, a sodium pyrophosphate or a sodium silicate, and the material of the lubricating layer is a lubricant.

10. The preparation method according to claim 9, wherein the preparation method comprises:
in a vacuum environment, mixing first dispersion liquid containing the rare earth ion-doped soft magnetic alloy core layer and a phosphoric acid, and performing first stirring, so that the phosphoric acid is reacted with the material in a surface area of the rare earth ion-doped soft magnetic alloy core layer to coat the outer surface thereof and form the phosphating layer, to obtain an intermediate material A, wherein the material of the phosphating layer contains the iron phosphate and the aluminum phosphate;
under a condition of pH 6.0-8.0, performing second stirring on second dispersion liquid containing the intermediate material A, the ethyl silicate, the sodium pyrophosphate and the sodium silicate, as to react on the outer surface, away from the rare earth ion-doped soft magnetic alloy core layer, of the phosphating layer and form the glass layer, to obtain an intermediate material B, wherein the glass layer contains the silicon dioxide, the sodium pyrophosphate and the sodium silicate;
performing third stirring on third dispersion liquid containing the intermediate material B and the coupling agent, as to connect the coupling agent on the outer surface, away from the rare earth ion-doped soft magnetic alloy core layer, of the glass layer, to obtain an intermediate material C; and
mixing the intermediate material C and the lubricant, and performing fourth stirring, and making the lubricant is coated on the surface of the glass layer by coupling with the coupling agent to form the lubricating layer, thereby forming the soft magnetic composite material.

11. The preparation method according to claim 10, wherein the usage amount of the phosphoric acid is 0.5-1% of the weight of the rare earth ion-doped soft magnetic alloy core layer;
preferably, the usage amount of the ethyl silicate is 0.5-1% of the weight of the rare earth ion-doped soft magnetic alloy core layer, the usage amount of the sodium pyrophosphate is 0.2-0.5% of the weight of the rare earth ion-doped soft magnetic alloy core layer, and the usage amount of the sodium silicate is 0.5-1% of the weight of the rare earth ion-doped soft magnetic alloy core layer;
preferably, the usage amount of the coupling agent is 0.5-1.0% of the weight of the rare earth ion-doped soft magnetic alloy core layer; and
preferably, the usage amount of the lubricant is 0.1-1% of the weight of the rare earth ion-doped soft magnetic alloy core layer.

12. The preparation method according to claim 10, wherein the treatment temperatures of the first stirring, the second stirring, the third stirring and the fourth stirring are each independently selected from 50-100° C., and the treatment times are each independently 1-5 h.

13. An application of the soft magnetic composite material according to claim 7 in an inductance device of a MHz frequency band.

14. The rare earth ion-doped soft magnetic alloy according to claim 2, wherein the average particle diameter of the rare earth ion-doped soft magnetic alloy is 5-50 μm.

15. The preparation method according to claim 4, wherein the rare earth element is selected from at least one of Ce, La, Sm, Nd, Pr and Ho.

16. The preparation method according to claim 5, wherein in the smelting process, the smelting temperature is 1800-2000° C., and the smelting time is 0.5-5 h;
preferably, in the heat treatment process, the treatment temperature is 900-1000° C., and the treatment time is 2-3 h; and
referably, a gas atomization device is used to perform the atomization powder preparation; more preferably, in the gas atomization device, an atomizing gas is an inert gas, and its gas pressure is 0.1-1.0 MPa.

17. The soft magnetic composite material according to claim 7, wherein the rare earth element is selected from at least one of Ce, La, Sm, Nd, Pr and Ho.

18. The soft magnetic composite material according to claim 7, wherein the average particle diameter of the rare earth ion-doped soft magnetic alloy is 5-50 μm.

19. The application of the soft magnetic composite material according to claim 13, wherein the coupling agent is selected from one or more of a silane coupling agent, a titanate coupling agent or an aluminate coupling agent;
preferably, the lubricant is selected from one or more of a zinc stearate, a calcium stearate or a magnesium stearate;
preferably, the average particle diameter of the soft magnetic composite material is 10-40 μm; and
preferably, the thickness of the phosphating layer is 10-50 nm, the thickness of the glass layer is 10-50 nm, and the thickness of the lubricating layer is 10-50 nm.
